(19) United States
(12) Patent Application Publication
(10) Pub. No.: US 2026/0233464 A1
(43) Pub. Date: Aug. 13, 2026

(54) METHOD FOR MONITORING THE FUNCTION OF A PRINT HEAD OF A 3D PRINTER, METHOD FOR MONITORING THE FUNCTION OF A PRINT HEAD OF A 3D PRINTER IN COMBINATION WITH A METHOD FOR CLEANING THE PRINT HEAD, AND 3D PRINTER

(71) Applicant: ExOne GmbH, Gersthofen (DE)

(72) Inventors: Johannes HILLMANN, Langenau (DE); Christian HEUFELDER, Augsburg (DE)

(21) Appl. No.: 19/156,409

(22) PCT Filed: Jan. 31, 2024
(86) PCT No.: PCT/EP2024/052395

§ 371 Date: Aug. 14, 2025

(30) Foreign Application Priority Data
Feb. 16, 2023 (DE) 102023103886.9

(51) Int. Cl. B29C 64/35; B08B 9/032; B29C 64/165; B29C 64/209; B29C 64/393; B33Y 10/00; B33Y 30/00; B33Y 40/00; B33Y 50/02; G06T 7/00

(52) U.S. Cl. CPC B29C 64/35; B08B 9/0321; B29C 64/165; B29C 64/209; B29C 64/393; B33Y 10/00; B33Y 30/00; B33Y 40/00; B33Y 50/02; G06T 7/001; B08B 2209/032; G06T 2207/30144

(57) ABSTRACT

A method is disclosed for monitoring the function of a print head of a 3D printer which is configured to build up a component in layers by selectively dispensing liquid treatment agent from nozzles of the print head onto a previously applied layer of loose particle material. The method includes selectively controlling several nozzles of the print head to dispense liquid treatment agent from the nozzles, determining a mass of the liquid treatment agent dispensed from the nozzles and comparing the determined mass with a set value, and capturing an image of liquid treatment agent dispensed from the nozzles and evaluating the image to identify malfunctioning nozzles.

### CROSS-REFERENCE TO RELATED APPLICATION

The present application is a national stage entry according to 35 U.S.C. § 371 of PCT application No.: PCT/EP2024/052395 filed on Jan. 31, 2024; which claims priority to German Patent Application Serial No.: 10 2023 103 886.9 filed on Feb. 16, 2023; all of which are incorporated herein by reference in their entirety and for all purposes.

### FIELD

Various embodiments of the present disclosure relate to a method for monitoring the function of a print head of a 3D printer, a method for monitoring the function of a print head of a 3D printer in combination with a method for cleaning the print head, and a 3D printer.

### SUMMARY

Various generative manufacturing processes or 3D printing processes and, consequently, various types of 3D printers, i.e., machines/systems for building a component in layers, are known.

Some generative manufacturing processes have the following steps in common:
(1) First, particle material (or particulate building material) is applied over the entire surface/continuously to a building field to form a layer of unsolidified particle material.
(2) The applied layer of unsolidified particle material is selectively solidified in a predetermined partial area (corresponding to the component to be manufactured), for example by selectively printing (for example liquid) a treatment agent, for example a binding material, for example a binder.
(3) Steps (1) and (2) are repeated to manufacture at least one desired component. For this purpose, for example, a building platform on which the component is built up in layers may be lowered by one layer thickness before a new layer is applied (alternatively, for example, a/the coating device and a/the printing device may be raised by one layer thickness).
(4) Finally, the at least one manufactured component, which is formed from the solidified partial areas and is supported and surrounded by loose, non-solidified particle material, may be unpacked.

A/the building space in which the component or components is/are manufactured may be defined, for example, by a so-called building box (also called a “job box”), for example by an interchangeable container. Such a building box may have an upwardly open, vertically extending peripheral wall structure (for example formed by four vertical side walls), which may, for example, be rectangular in the plan view. A height-adjustable building platform may be accommodated in the building box. The space above the building platform and between the vertical peripheral wall structure can, for example, at least partially co-form the building space. An upper area of the building space may, for example, be referred to as a building field. A building box is described, for example, in DE 10 2009 056 696 A1.

One or more three-dimensional components may be built up in layers in a/the building space, for example by selectively solidifying several adjacent layers of building material in a respective partial area thereof, for example by binder jetting, i.e., by (selectively) “bonding” the (particulate) building material with a (for example, liquid) treatment agent, for example a binding agent, for example a binder.

In the above step (1), a coater (also called a “recoater”) is usually used. Various coaters are known for use in a 3D printer, with which a particulate building material may be applied to the building field (also called the building surface or the building area) in the form of a uniform, full-surface/continuous layer.

One type of coater uses a roller (short for “roller coater”), in front of which a quantity of particulate building material is first deposited and which is then moved horizontally across the building field to apply the particulate building material to the building field in the form of an even layer. The roller may be rotated in the opposite direction.

Another type of coater (known as a “container coater”, for example, a “slot coater”) uses a container that defines an inner cavity for receiving particulate building material and has a (for example, elongated) discharge area, for example comprising an (for example, elongated) discharge slot, for discharging the particulate building material. The container coater may, for example, be movable across a/the building field (for example, horizontally, for example, transversely to its longitudinal direction), wherein the particulate building material may be dispensed through the (elongated) discharge area onto the building field, to thereby apply an even, full-surface/continuous layer of building material to the building field or the building platform. The coater may, for example, be elongated in order to span or cover the length or width of a rectangular building field. Coaters are described, for example, in DE 10 2009 056 689 A1 and EP 3 753 709 A1.

In the above step (2), a printing device with a print head may be used, for example, which applies a liquid treatment agent in a controlled way to a partial area of a/the previously applied building material layer (known as “binder jetting”). The treatment agent contributes to a (an) (immediate and/or subsequent) solidification of the building material layer in the partial area. The treatment agent may, for example, be a binding agent. The treatment agent may, for example, be a binder. The treatment agent may, for example, be a component, for example an activator, of a multi-component binding agent system.

The print head may, for example, have one or more nozzles through which the liquid treatment agent may be dispensed or is dispensed. The one or more nozzles may each have a nozzle opening, for example. The one or more nozzles and/or the one or more nozzle openings may, for example, at least partially form a discharge area (e.g., treatment agent discharge area) of the print head, for example on a print head underside.

When performing a/the generative manufacturing process, for example, one or more nozzles of the print head may undergo functional limitations. For example, an amount of treatment agent dispensed by a nozzle may deviate from a set value, for example, it may be reduced or increased. One possible cause of this may be partial or complete blockage of one or more nozzles, for example due to at least partial solidification of (liquid) treatment agent in one or more nozzles and/or at one or more nozzle openings, and/or by (at least partially solidified, liquid) treatment agent adhering to the one or more nozzles and/or to the one or more nozzle openings, and/or by agitated particle material and/or dirt particles adhering to the one or more nozzles and/or to the one or more nozzle openings. This may, for example, influence (reduce or increase) a discharge quantity of (liquid) treatment agent from the one or more nozzles, and/or this may, for example, cause the binder droplets dispensed from the one or more nozzles to be deflected and/or deformed. This may, for example, cause the at least one component produced by the generative manufacturing process and constructed in layers to be defective.

It may therefore be necessary to monitor one/the print head, for example a/the function of the print head, for example on a regular basis. In addition, it may be necessary, as an alternative or in addition, to ensure and/or restore the function of the print head, for example to ensure and/or restore the function of one or more nozzles of the print head.

One or embodiments of the present disclosure relate to an improved method for monitoring the function of a print head of a 3D printer, an improved method for monitoring the function of a print head of a 3D printer in combination with a method for cleaning the print head, and an improved 3D printer.

Alternatively or in addition, one or more embodiments of the present disclosure relate to a method for monitoring the function of a print head of a 3D printer and a 3D printer with which a function of a print head may be monitored efficiently and/or reliably.

Alternatively or in addition, one or more embodiments of the present disclosure relate to a method for monitoring the function of a print head of a 3D printer and a 3D printer with which a malfunctioning (e.g., failed and/or clogged) nozzle of a print head may be detected and/or compensated efficiently and/or reliably.

Alternatively or in addition, one or more embodiments of the present disclosure relate to a method for monitoring the function of a print head of a 3D printer in combination with a method for cleaning the print head and a 3D printer, with which a function of a print head may be ensured and/or restored efficiently and/or reliably.

Alternatively or in addition, one or more embodiments of the present disclosure relate to a method for monitoring the function of a print head of a 3D printer, a method for monitoring the function of a print head of a 3D printer in combination with a method for cleaning the print head, and a 3D printer with which a component may be reliably manufactured in 3D printing by means of binder jetting.

According to a first aspect of the present disclosure, a method for monitoring the function of a print head of a 3D printer, which is configured to build up a component in layers by selectively dispensing liquid treatment agent from nozzles of the print head onto a previously applied layer of loose particle material, may comprise, for example: selectively activating several (for example, all of) nozzles of the print head to dispense liquid treatment agent from the nozzles; determining a mass of the liquid treatment agent dispensed from the nozzles and comparing the determined mass with a set value (for example, a mass dispensed when the selectively activated nozzles are functioning correctly); and capturing an image of the liquid treatment agent dispensed from the nozzles and evaluating the image to identify malfunctioning (e.g., partially or completely blocked and/or defective) nozzles.

By determining the mass of the liquid treatment agent dispensed from the nozzles and comparing the determined mass with a/the set value, it is possible, for example, to detect a presence of one or more malfunctioning (e.g., partially or completely blocked and/or defective) nozzles, for example if the determined mass deviates from the set value, for example if the determined mass is less than the set value. By recording and evaluating the image, the one or more malfunctioning nozzles may be identified, for example their position(s) in the print head. In this way, for example, the presence of at least one malfunctioning nozzle can first be detected and then the exact position of this nozzle (these nozzles) on the print head may be identified. This means, for example, that a malfunctioning nozzle of a print head may be detected efficiently and reliably, a function of the print head may be monitored efficiently and reliably, and a component may be reliably manufactured in 3D printing using binder jetting.

A malfunctioning nozzle may be understood, for example, as a partially or completely clogged nozzle. A malfunctioning nozzle may be understood, for example, as a defective nozzle. A malfunctioning nozzle may be understood, for example, as a nozzle whose output quantity of liquid treatment agent deviates from a quantity of liquid treatment agent output when the nozzle is functioning correctly, for example, reduced, for example due to a technical problem and/or defect in the print head itself, for example due to a defective piezo element for triggering an/the output of liquid treatment agent from the print head, or the like. A malfunctioning nozzle may be understood, for example, as a nozzle whose dispensed drops of liquid treatment agent are deflected and/or deformed. A/the set value may be understood, for example, as a mass that is dispensed when the selectively controlled nozzles are functioning correctly.

The liquid treatment agent may, for example, be a binding agent. The liquid treatment agent may, for example, be a binder. The liquid treatment agent may, for example, be a component, for example an activator, of a multi-component binding agent system.

The determination of the mass of the liquid treatment agent dispensed from the nozzles and the comparison of the determined mass with the set value may, for example, be carried out before the image is recorded and evaluated. This allows, for example, a malfunctioning nozzle of a print head to be detected efficiently and reliably, a function of the print head to be monitored efficiently and reliably, and a component to be reliably manufactured in 3D printing using binder jetting.

The image may be captured and evaluated, for example, if a deviation from the set value is detected when comparing the determined mass with the set value. This allows, for example, a malfunctioning nozzle of a print head to be detected efficiently and reliably, a function of the print head to be monitored efficiently and reliably, and a component to be reliably manufactured in 3D printing using binder jetting.

The image may be captured and evaluated, for example, if another specified criterion is met, such as if a specified number of monitoring operations have been performed or a specified time period has elapsed since the last image was captured and evaluated. This allows, for example, a malfunctioning nozzle of a print head to be detected efficiently and reliably, a function of the print head to be monitored efficiently and reliably, and a component to be reliably manufactured in 3D printing using binder jetting.

For example, it is possible, always or at least in part, to dispense with image capture and evaluation, if the determined mass corresponds to the set value. This allows, for example, a malfunctioning nozzle of a print head to be detected efficiently and reliably, a function of the print head to be monitored efficiently and reliably, and a component to be reliably manufactured in 3D printing using binder jetting.

The evaluation of the image may include, for example: comparing a dispensing pattern formed by the dispensed liquid treatment agent and recorded, with an arrangement pattern corresponding to the controlled nozzles of the print head, which is stored in a memory, for example, or generated depending on the controlled nozzles. This allows, for example, a malfunctioning nozzle of a print head to be detected efficiently and reliably, a function of the print head to be monitored efficiently and reliably, and a component to be reliably manufactured in 3D printing using binder jetting.

Comparing the dispensing pattern formed by the liquid treatment agent and recorded, with the arrangement pattern corresponding to the controlled nozzles of the print head may, for example, include: comparing the entire dispensing pattern with the entire arrangement pattern; and/or comparing a respective section of the dispensing pattern with a respective, associated section of the arrangement pattern, for example for several or all of the controlled nozzles; and/or comparing an area of a respective spot formed by the dispensed liquid treatment agent in the captured image with a respective, associated partial section of the arrangement pattern, for example for several or all of the controlled nozzles. This allows, for example, a malfunctioning nozzle of a print head to be detected efficiently and reliably, a function of the print head to be monitored efficiently and reliably, and a component to be reliably manufactured in 3D printing by means of binder jetting.

The image may be captured, for example, by means of an image capture device (e.g., a camera) of the 3D printer, which is configured to capture an image of the liquid treatment agent dispensed from the nozzles. The print head may, for example, be positioned above a treatment agent target area within the 3D printer, which is configured to receive the liquid treatment agent dispensed from the nozzles, in order to capture the image. The liquid treatment agent dispensed from the nozzles may, for example, be dispensed onto the treatment agent target area, for example onto a treatment agent receiving surface formed by the treatment agent target area (and arranged within the 3D printer). The print head may, for example, first be positioned above the treatment agent target area to capture the image (for example, by moving the print head to the treatment agent target area until it is positioned above it), then the liquid treatment agent may be dispensed from the nozzles of the print head, then the print head may be moved away from the treatment agent target area (for example, to a position in which the print head is no longer positioned above the treatment agent target area), and then the image may be captured. The image capture device may, for example, be arranged within the 3D printer. The treatment agent target area may, for example, be arranged next to and/or adjacent to a/the building field and/or a/the building space of the 3D printer. The image capture device may, for example, be arranged above or below the treatment agent target area and/or the treatment agent receiving surface. This allows, for example, a malfunctioning nozzle of a print head to be detected efficiently and reliably, a function of the print head to be monitored efficiently and reliably, and a component to be reliably manufactured in 3D printing by means of binder jetting.

The print head may, for example, be positioned above a weighing device (e.g., a scale) of the 3D printer, which is configured to determine the mass of the liquid treatment agent dispensed from the nozzles, in order to determine the mass of the liquid treatment agent dispensed from the nozzles. The weighing device may, for example, be arranged inside the 3D printer. The weighing device may, for example, be arranged next to and/or adjacent to a/the building field and/or a/the building space of the 3D printer. The weighing device may, for example, be arranged next to and/or adjacent to the treatment agent target area. This allows, for example, a malfunctioning nozzle of a print head to be detected efficiently and reliably, a function of the print head to be monitored efficiently and reliably, and a component to be reliably manufactured in 3D printing by means of binder jetting.

The evaluation of the image and/or the comparison of the determined mass with the set value may, for example, be carried out automatically by means of a control device of the 3D printer, for example by means of artificial intelligence, for example using an artificial neural network. This allows, for example, a malfunctioning nozzle of a print head to be detected efficiently and reliably, a function of the print head to be monitored efficiently and reliably, and a component to be reliably manufactured in 3D printing using binder jetting.

The treatment target area may, for example, be formed by the weighing device, for example by a weighing tray of the weighing device, which may be replaceable and/or be able to be wiped clean. This allows, for example, a malfunctioning nozzle of a print head to be detected efficiently and reliably, a function of the print head to be monitored efficiently and reliably, and a component to be reliably manufactured in 3D printing using binder jetting.

The weighing device and the treatment agent target area may, for example, be arranged separately from one another. The weighing device and the treatment agent target area may, for example, be arranged next to and/or adjacent to one another.

The weighing device and the treatment agent target area may, for example, be arranged next to and/or adjacent to a building field and/or a building box of the 3D printer. The treatment agent target area may, for example, be formed by a building field and/or a powder bed of the 3D printer, for example by an area thereof not used for the component. The treatment agent target area may, for example, have a target surface, for example a transparent and/or wipeable and/or replaceable target surface, for example a sheet of paper or a glass plate. This allows, for example, a malfunctioning nozzle of a print head to be detected efficiently and reliably, a function of the print head to be monitored efficiently and reliably, and a component to be reliably manufactured in 3D printing by means of binder jetting.

The image capture device may, for example, be arranged above the treatment agent target area and/or directed toward it. The image capture device may, for example, be arranged below the transparent, for example wipeable and/or replaceable, target surface, for example the glass plate, and/or directed toward it. This allows, for example, a malfunctioning nozzle of a print head to be detected efficiently and reliably, a function of the print head to be monitored efficiently and reliably, and a component to be reliably manufactured in 3D printing using binder jetting.

According to a second aspect of the present disclosure, the method described above according to the first aspect of the present disclosure may be carried out, for example, in combination with a method for cleaning the print head.

According to the second aspect of the present disclosure, the method described above according to the first aspect of the present disclosure, in combination with a/the method for cleaning the print head, may, for example, comprise: cleaning the nozzles of the print head, for example by means of a print head cleaning device of the 3D printer and/or by moving the print head across a/the print head cleaning device of the 3D printer, for example several times, and/or by flushing the nozzles with a liquid treatment agent. The nozzles may be cleaned, for example, if malfunctioning nozzles are identified during image evaluation and/or if a deviation from the set value is detected when comparing the determined mass with the set value.

This allows, for example, a function of the print head to be efficiently and reliably ensured and/or restored, and a component may be reliably manufactured in 3D printing using binder jetting.

The printhead cleaning device of the 3D printer and/or the method for cleaning the printhead may, for example, be designed as described in one of the documents DE 10 2009 056 695 A1, DE 20 2019 102 983 U1 and DE 10 2022 101 946 A1, the contents of which are incorporated herein by reference.

After cleaning the nozzles, it is possible, for example, to determine again the mass of the liquid treatment agent dispensed from the nozzles and compare the determined mass with the set value and/or to record and evaluate an image. The cleaning of the nozzles and the determination of the mass of the liquid treatment agent dispensed from the nozzles and comparison of the determined mass with the set value and/or the recording and evaluation of the image may, for example, be repeated several times, for example until the determined mass corresponds to the set value and/or no more malfunctioning nozzles are identified during the evaluation of the image and/or a termination criterion is fulfilled, for example a maximum number of repetitions. This allows, for example, the function of the print head to be efficiently and reliably ensured and/or restored, and a component may be reliably manufactured in 3D printing using binder jetting.

The methods according to the first and/or second aspect of the present disclosure may, for example, comprise: disabling a nozzle identified as malfunctioning and optionally compensating for the disabled nozzle, for example by selectively increasing the amount of liquid treatment agent dispensed from one or more nozzles arranged adjacent to the disabled nozzle, and/or by positioning, for example, moving the print head during a second pass of the print head over a/the building field of the 3D printer, so that an area to be printed during a first pass of the print head over the building field by the disabled nozzle is printed during the second pass of the print head over the building field by a nozzle that is not malfunctioning. This allows, for example, a function of the print head to be ensured efficiently and reliably, and a component may be reliably manufactured in 3D printing using binder jetting.

The methods according to the first and/or second aspect of the present disclosure may, for example, comprise: continuing to operate a nozzle identified as malfunctioning and compensating for the amount of liquid treatment agent dispensed from the nozzle identified as malfunctioning, for example by selectively adjusting, for example increasing or decreasing, the amount of liquid treatment agent dispensed from one or more nozzles arranged adjacent to the nozzle identified as malfunctioning, and/or by selectively adjusting, for example increasing or decreasing, the amount of liquid treatment agent dispensed from a nozzle identified as malfunctioning to a target amount, for example by adjusting parameters, for example a pulse time and/or a frequency and/or a voltage, for selectively controlling the nozzle identified as malfunctioning. This allows, for example, a function of the print head to be ensured efficiently and reliably, and a component may be reliably manufactured in 3D printing using binder jetting.

For example, the amount of liquid treatment agent dispensed may be selectively increased by controlling a/the nozzle in such a way that several (for example two, for example three) drops are dispensed, for example by means of a first pulse, through which a/the first drop is dispensed, and by means of a second pulse, through which a/the second drop is dispensed, and optionally by means of a third pulse, through which a/the third drop is dispensed. For example, the adjustment of parameters may include: adjusting a pulse number, for example so that several (for example two, for example three) drops are dispensed, for example by controlling a/the nozzle with several (for example two, for example three) pulses in such a way that by means of the several (for example two, for example three) pulses several (for example two, for example three) drops are dispensed, for example by means of a first pulse a first drop is dispensed and by means of a second pulse a second drop is dispensed, and optionally a third drop is dispensed by means of a third pulse.

The methods according to the first and/or second aspect of the present disclosure may, for example, comprise: replacing a nozzle identified as malfunctioning. This allows, for example, a function of the print head to be efficiently and reliably ensured and/or restored, and a component to be reliably manufactured in 3D printing by means of binder jetting.

According to a third aspect of the present disclosure, a 3D printer that is configured to build up a component in layers by selectively dispensing liquid treatment agent from nozzles of a print head onto a previously applied layer of loose particle material may, for example, comprise: a print head comprising a plurality of nozzles and configured to selectively dispense a liquid treatment agent from the nozzles; a weighing device (e.g., a scale) configured to determine a mass of the liquid treatment agent dispensed from the nozzles; an image capture device (e.g., a camera) configured to capture an image of the liquid treatment agent dispensed from the nozzles; and a control device which is configured to compare the mass determined by the weighing device with a set value and to evaluate the image captured by the image capture device in order to identify malfunctioning nozzles; wherein the print head may be positioned above the weighing device.

By determining the mass of the liquid treatment agent dispensed from the nozzles using the weighing device and comparing the mass determined by the weighing device with a/the set value using the control device, it is possible, for example, to detect a presence of one or more malfunctioning (e.g., partially or completely clogged and/or defective) nozzles, for example if the mass determined by the weighing device deviates from the set value, for example if the mass determined by the weighing device is less than the set value. By taking the image using the image capture device and evaluating the image captured by the image capture device using the control device, it is possible, for example, to identify the one or more malfunctioning nozzles, for example their position(s) in the print head. In this way, for example, the presence of at least one malfunctioning nozzle can first be detected and then the exact position of this nozzle or these nozzles on the print head may be identified. Thus, for example, a malfunctioning nozzle of a print head may be detected efficiently and reliably, a function of the print head may be monitored efficiently and reliably, and a component may be reliably manufactured in 3D printing by means of binder jetting.

A malfunctioning nozzle may be understood, for example, as a partially or completely clogged nozzle. A malfunctioning nozzle may be understood, for example, as a defective nozzle. A malfunctioning nozzle may be understood, for example, as a nozzle whose output quantity of liquid treatment agent deviates from the quantity of liquid treatment agent output when the nozzle is functioning correctly, for example, reduced, for example due to a technical problem and/or defect in the print head itself, for example due to a defective piezo element for triggering an/the output of liquid treatment agent from the print head, or the like. A malfunctioning nozzle may be understood, for example, as a nozzle whose dispensed drops of liquid treatment agent are deflected and/or deformed. A set value may be understood, for example, as a mass that is dispensed when the selectively controlled nozzles are functioning correctly.

The liquid treatment agent may, for example, be a binding agent. The liquid treatment agent may, for example, be a binder. The liquid treatment agent may, for example, be a component, for example an activator, of a multi-component binding agent system. The control device may, for example, be configured to selectively control the nozzles of the print head so that the controlled nozzles receive a signal to dispense the liquid treatment agent. The control device may, for example, be configured to position the print head above the weighing device.

The 3D printer may, for example, comprise a treatment agent target area which is arranged within the 3D printer and is configured to receive the liquid treatment agent dispensed from the nozzles, at least for the purpose of capturing the image. The print head may, for example, be positionable above the treatment agent target area. The control device may, for example, be configured to position the print head above the treatment agent target area. The print head may, for example, be configured to output the liquid treatment agent dispensed from the nozzles onto the treatment agent target area, for example onto a treatment agent receiving surface formed by the treatment agent target area (and located within the 3D printer). The image capture device may, for example, be arranged within the 3D printer. The treatment agent target area may, for example, be arranged next to and/or adjacent to a/the building field and/or a/the building space of the 3D printer. The image capture device may, for example, be arranged above or below the treatment agent target area and/or the treatment agent receiving surface. This allows, for example, a malfunctioning nozzle of a print head to be detected efficiently and reliably, a function of the print head to be monitored efficiently and reliably, and a component to be reliably manufactured in 3D printing by means of binder jetting.

The treatment target area may, for example, be formed by the weighing device, for example by a replaceable and/or wipeable weighing tray of the weighing device. This allows, for example, a malfunctioning nozzle of a print head to be detected efficiently and reliably, a function of the print head to be monitored efficiently and reliably, and a component to be reliably manufactured in 3D printing by means of binder jetting.

The weighing device and the treatment agent target area may, for example, be arranged separately from one another. The weighing device and the treatment agent target area may, for example, be arranged next to and/or adjacent to one another. The weighing device and the treatment agent target area may, for example, be arranged next to and/or adjacent to a building field and/or a building box of the 3D printer. The treatment agent target area may, for example, be formed by a building field and/or a powder bed of the 3D printer, for example by an area thereof not used for the component. The treatment agent target area may, for example, have a target surface, for example a transparent and/or wipeable and/or replaceable target surface, for example a sheet of paper or a glass plate. This allows, for example, a malfunctioning nozzle of a print head to be detected efficiently and reliably, a function of the print head to be monitored efficiently and reliably, and a component to be reliably manufactured in 3D printing by means of binder jetting.

The image capture device may, for example, be arranged above the treatment agent target area and/or directed toward it. The image capture device may, for example, be arranged below the transparent, for example wipeable and/or replaceable, target surface, for example the glass plate, and/or directed toward it. This allows, for example, a malfunctioning nozzle of a print head to be detected efficiently and reliably, a function of the print head to be monitored efficiently and reliably, and a component to be reliably manufactured in 3D printing using binder jetting.

The 3D printer may, for example, comprise a print head cleaning device that is configured to clean the nozzles of the print head. The print head cleaning device may, for example, be designed as described in one of documents DE 10 2009 056 695 A1, DE 20 2019 102 983 U1 and DE 10 2022 101 946 A1, the contents of which are incorporated herein by reference. This allows, for example, a function of the print head to be efficiently and reliably ensured and/or restored, and a component may be reliably manufactured in 3D printing using binder jetting.

The control device may, for example, be configured to move the print head across the print head cleaning device, for example multiple times, for cleaning the nozzles. The control device may, for example, be configured to control the nozzles of the print head so that they are flushed through with a liquid treatment agent for cleaning the nozzles. The control device may, for example, be configured to control the print head and/or the print head cleaning device in such a way that the nozzles are cleaned if malfunctioning nozzles are identified during image evaluation and/or if a deviation from the set value is detected when comparing the determined mass with the set value. The control device may, for example, be configured to control the print head, the weighing device, and the image capture device in such a way that, after cleaning the nozzles, the mass of liquid treatment agent dispensed from the nozzles is determined again and the determined mass is compared with the set value and/or an image is recorded and evaluated. The control device may be configured, for example, to control the print head and/or the print head cleaning device, the weighing device, and the image capture device in such a way that the cleaning of the nozzles and the determination of the mass of the liquid treatment agent dispensed from the nozzles and the comparison of the determined mass with the set value and/or the capture and evaluation of the image are carried out repeatedly, for example until the determined mass corresponds to the set value and/or no malfunctioning nozzles are identified during the evaluation of the image and/or a termination criterion is fulfilled, for example a maximum number of repetitions. This allows, for example, a function of the print head to be efficiently and reliably ensured and/or restored, and a component may be reliably manufactured in 3D printing using binder jetting.

The control device may, for example, be configured to automatically evaluate the captured image and/or automatically compare the determined mass with the set value, for example by means of artificial intelligence, for example using an artificial neural network. The control device may, for example, be configured to control the 3D printer in such a way that a method according to the above-described first and/or second aspect of the present disclosure is carried out. This allows, for example, a malfunctioning nozzle of a print head to be detected efficiently and reliably, a function of the print head to be monitored efficiently and reliably, a function of the print head to be ensured and/or restored efficiently and reliably, and a component to be reliably manufactured in 3D printing using binder jetting.

The control device may, for example, be configured to compare, during image evaluation, a dispensing pattern formed by the liquid treatment agent dispensed by the print head and captured by the image capture device with an arrangement pattern corresponding to the controlled nozzles of the print head, which is stored, for example, in a memory of the 3D printer or is generated depending on the nozzles controlled. The control device may, for example, be configured to compare the entire dispensing pattern with the entire arrangement pattern. The control device may, for example, be configured to compare a respective section of the dispensing pattern with a respective, assigned section of the arrangement pattern, for example for several or all of the controlled nozzles. The control device may, for example, be configured to optionally compare an area of a respective spot formed by the output liquid treatment agent in the captured image with a respective, associated partial section of the arrangement pattern, for example for several or all of the controlled nozzles. This allows, for example, a malfunctioning nozzle of a print head to be detected efficiently and reliably, a function of the print head to be monitored efficiently and reliably, and a component to be reliably manufactured in 3D printing by means of binder jetting.

The control device may, for example, be configured to control the print head, the weighing device, and the image capture device in such a way that a mass of the liquid treatment agent dispensed from the nozzles is determined and the determined mass is compared with the set value before an image is captured and the image is evaluated. The control device may, for example, be configured to control the print head, the weighing device, and the image capture device in such a way that the image is captured and evaluated when a deviation from the set value is detected when comparing the determined mass with the set value. The control device may, for example, be configured to control the print head, the weighing device and the image capture device in such a way that the image is recorded and evaluated when another specified criterion is met, for example, a specified number of monitoring operations have been performed or a specified time period has elapsed since the last capture and evaluation of an image by means of the image capture device. The control device may be configured, for example, to control the print head, the weighing device, and the image capture device in such a way that the capture and evaluation of the image is omitted always or at least in part, if the determined mass corresponds to the set value. This allows, for example, a malfunctioning nozzle of a print head to be detected efficiently and reliably, a function of the print head to be monitored efficiently and reliably, and a component to be reliably manufactured in 3D printing using binder jetting.

The control device may, for example, be configured to control the print head in such a way that a nozzle identified as malfunctioning is disabled and, optionally, the disabled nozzle is compensated for, for example by selectively increasing the amount of liquid treatment agent dispensed from one or more nozzles located adjacent to the disabled nozzle, and/or by positioning, for example by moving the print head during a second pass of the print head across a/the building field of the 3D printer, so that an area to be printed during a first pass of the print head across the building field by the disabled nozzle is printed during the second pass of the print head across the building field by a nozzle that is not malfunctioning. The control device may, for example, be configured to control the print head in such a way that a nozzle identified as malfunctioning continues to operate and the amount of liquid treatment agent dispensed from the nozzle identified as malfunctioning is compensated for, for example by selectively adjusting, for example increasing or decreasing the amount of liquid treatment agent dispensed from one or more nozzles arranged adjacent to the nozzle identified as malfunctioning, and/or by selectively adjusting, for example increasing or decreasing, the amount of liquid treatment agent dispensed from a nozzle identified as malfunctioning to a target amount, for example by adjusting parameters, for example a pulse time and/or a frequency and/or a voltage, for selectively controlling the nozzle identified as malfunctioning. This allows, for example, a function of the print head to be efficiently and reliably ensured and/or restored, and a component to be reliably manufactured in 3D printing using binder jetting.

For example, the control device may be configured to control the print head in such a way that the amount of liquid treatment agent dispensed is selectively increased by controlling a/the nozzle in such a way that several (for example two, for example three) drops are dispensed, for example by means of a first pulse, by which a/the first drop is dispensed, and by means of a second pulse, by which a/the second drop is dispensed, and optionally by means of a third pulse, by which a/the third drop is dispensed. For example, the control device may be configured to control the print head in such a way that the adjustment of parameters includes adjusting a pulse number, for example so that several (for example two, for example three) drops are dispensed, for example by controlling a/the nozzle with several (for example two, for example three) pulses in such a way that by means of the several (for example two, for example three) pulses, several (for example two, for example three) drops are dispensed, for example by means of a first pulse a first drop is dispensed and by means of a second pulse a second drop is dispensed, and optionally by means of a third pulse a third drop is dispensed.

### BRIEF DESCRIPTION OF THE DRAWINGS

Exemplary but not limiting embodiments of the present disclosure are shown in the Figures and are explained in more detail below.

FIG. 1 shows a method for monitoring the function of a print head of a 3D printer according to a first embodiment of the present disclosure.

FIG. 2(a) shows an arrangement pattern of controlled nozzles of a print head. FIG. 2(b), 2(c) and 2(d) show different dispensing patterns formed by dispensed liquid treatment agent.

FIG. 3 shows a method for monitoring the function of a print head of a 3D printer in combination with a method for cleaning the print head according to a second embodiment of the present disclosure.

FIG. 4 shows a method for monitoring the function of a print head of a 3D printer according to a third embodiment of the present disclosure.

FIG. 5 shows a method for monitoring the function of a print head of a 3D printer according to a fourth embodiment of the present disclosure.

FIG. 6 shows a method for monitoring the function of a print head of a 3D printer according to a fifth embodiment of the present disclosure.

FIG. 7 shows a 3D printer according to a sixth embodiment of the present disclosure.

FIG. 8 shows a 3D printer according to a seventh embodiment of the present disclosure.

FIG. 9 shows a 3D printer according to an eighth embodiment of the present disclosure.

FIG. 10 shows a 3D printer according to a ninth embodiment of the present disclosure.

FIG. 11 shows a 3D printer according to a tenth embodiment of the present disclosure.

### DETAILED DESCRIPTION

The following description refers to the accompanying Figures, which form part thereof and show specific embodiments of the present disclosure.

It is understood that other embodiments may be used and structural or logical changes may be made without departing from the scope of the present disclosure. It is understood that the features of the embodiments described herein may be combined with each other unless specifically stated otherwise. The following description is therefore not to be understood as limiting, and the scope of protection of the present disclosure is defined by the appended claims.

In the figures, identical or similar elements are given identical reference numerals where appropriate.

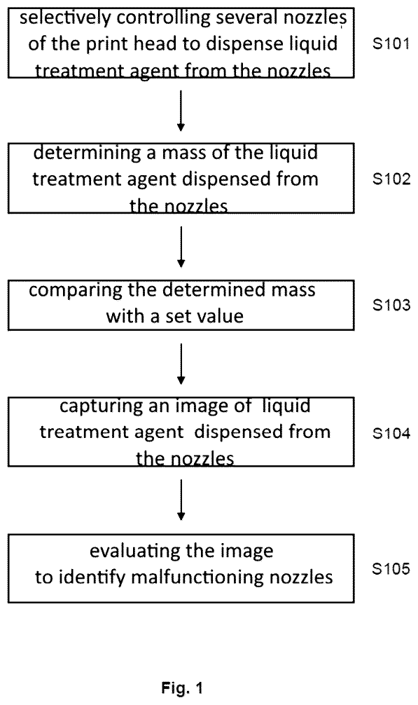

As shown, for example, in FIGS. 1 and 3-6, a method for monitoring the function of a print head 24 of a 3D printer 22, which is configured to build up a component in layers by selectively dispensing liquid treatment agent from nozzles of the print head 24 onto a previously applied layer of loose particle material, may, for example, comprise: selectively controlling several nozzles of the print head 24 to dispense liquid treatment agent from the nozzles S101, determining a mass of the liquid treatment agent dispensed from the nozzles S102 and comparing the determined mass with a set value S103, and capturing an image of the liquid treatment agent S104 dispensed from the nozzles and evaluating the image to identify malfunctioning nozzles S105.

As shown, for example, in FIGS. 1 and 3-6, the determination of the mass of the liquid treatment agent dispensed from the nozzles and the comparison of the determined mass with the set value S102, S103 may be carried out, for example, before the image is captured and evaluated S104, S105. Alternatively, the image may be captured and evaluated S104, S105 before determining the mass of the liquid treatment agent dispensed from the nozzles and comparing the determined mass with the set value S102, S103.

Capturing and evaluating the image S104, S105 may be carried out, for example, if a deviation from the set value is detected when comparing the determined mass with the set value S103. Capturing and evaluating the image S104, S105 may be carried out, for example, if another specified criterion is met, for example, a specified number of monitoring operations has been performed or a specified time period has elapsed since the last capture and evaluation of an image S104, S105. For example, capture and evaluation of the image S104, S105 may always or at least partially be omitted if the determined mass corresponds to the set value.

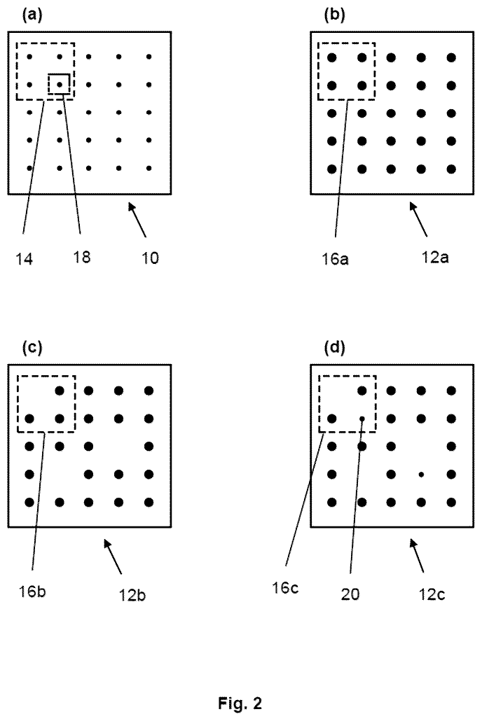

As shown in FIG. 2, for example, the evaluation of image S105 may comprise: comparing a dispensing pattern 12a, 12b, 12c formed by the dispensed liquid treatment agent, and captured, with an arrangement pattern 10 corresponding to the controlled nozzles of the print head 24, which is stored, for example, in a memory or generated depending on the controlled nozzles.

FIG. 2(b), 2(c) and 2(d) show different dispensing patterns 12a, 12b, 12c formed by the dispensed liquid treatment agent and captured, and FIG. 2(a) shows an arrangement pattern 10 corresponding to the controlled nozzles of the print head 24. In the dispensing pattern shown in FIG. 2(b), the same amount of liquid treatment agent was dispensed from all controlled nozzles. Thus, there are no malfunctioning nozzles. In the dispensing pattern shown in FIG. 2(c), no liquid treatment agent was dispensed from three of the controlled nozzles. Thus, there are three malfunctioning nozzles. In the dispensing pattern shown in FIG. 2(d), three of the controlled nozzles did not dispense any liquid treatment agent and two of the controlled nozzles dispensed less liquid treatment agent than should have been dispensed when functioning correctly. This means that five nozzles are malfunctioning, with three nozzles completely failing and two nozzles dispensing too little liquid treatment agent. As shown in FIG. 2(b)-2(c), for example, comparing the dispensing pattern 12a, 12b, 12c formed by the dispensed liquid treatment agent and recorded, with the arrangement pattern 10 corresponding to the controlled nozzles of the print head 24, may comprise: comparing the entire dispensing pattern 12a, 12b, 12c with the entire arrangement pattern 10; and/or comparing a respective section 16a, 16b, 16c of the dispensing pattern 12a, 12b, 12c with a respective, associated section 14 of the arrangement pattern 10, for example for several or all of the controlled nozzles; and/or comparing an area of a respective spot 20 formed by the dispensed liquid treatment agent in the captured image with a respective, associated section 18 of the arrangement pattern 10, for example for several or all of the controlled nozzles.

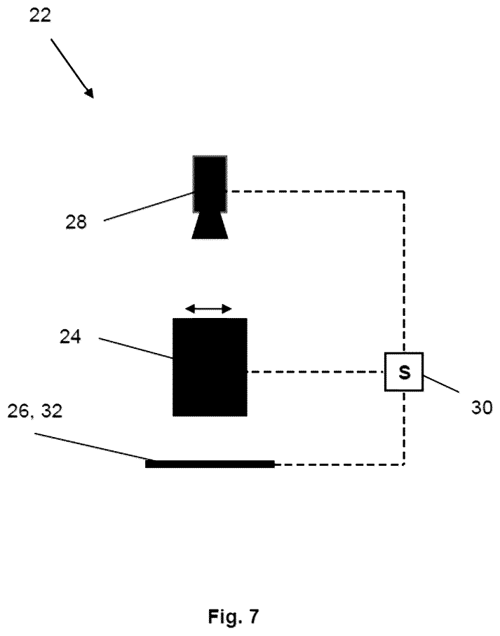

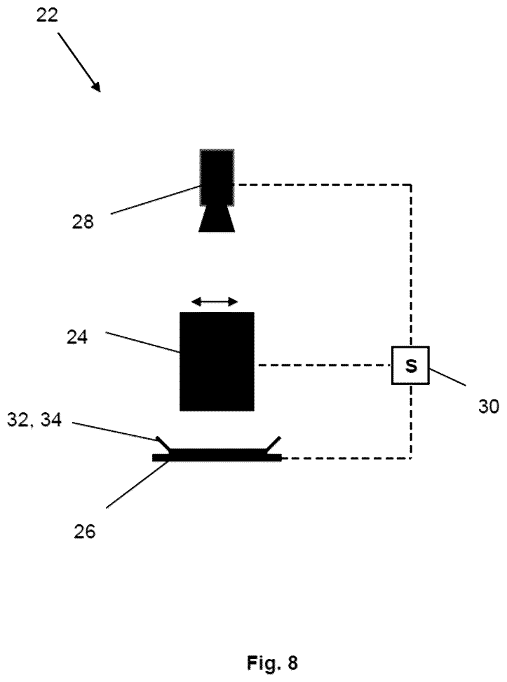

Capturing the image S104 may be carried out, for example, by means of an image capture device 28 of the 3D printer 22, which is configured to capture an image of the liquid treatment agent dispensed from the nozzles (see, for example, FIGS. 7-11). The print head 24 may, for example, be positioned above a treatment agent target area 32 within the 3D printer 22 for capturing the image S104, which is configured to receive the liquid treatment agent dispensed from the nozzles (see, for example, FIGS. 7 and 8). The print head 24 may, for example, be positioned above a weighing device 26 of the 3D printer 22 for determining the mass of the liquid treatment agent S102 dispensed from the nozzles, which is configured to determine the mass of the liquid treatment agent dispensed from the nozzles (see, for example, FIGS. 7-11). The evaluation of the image S105 and/or the comparison of the determined mass with the set value S103 may, for example, be carried out automatically by means of a control device 30 of the 3D printer 22, for example by means of artificial intelligence.

The treatment agent target area 32 may, for example, be formed by the weighing device 26, for example by a weighing tray 34 of the weighing device 26, which is, for example, replaceable and/or wipeable (see, for example, FIGS. 7 and 8).

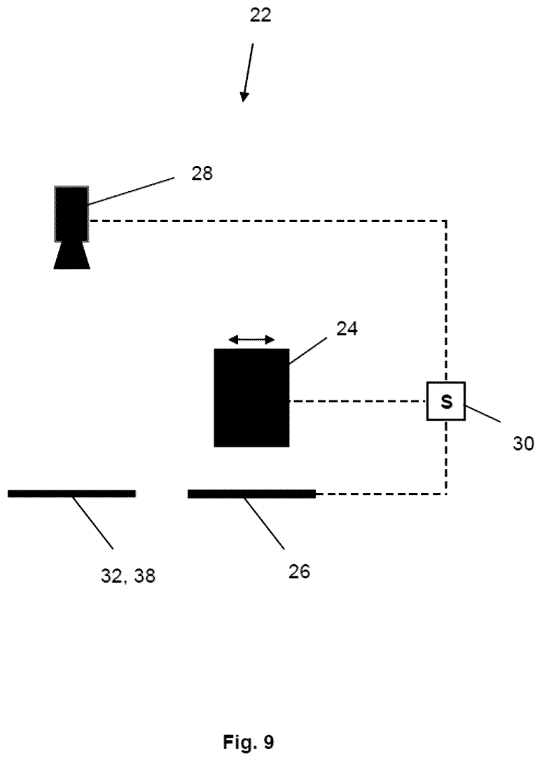

The weighing device 26 and the treatment agent target area 32 may, for example, be arranged separately from one another (see, for example, FIGS. 9-11). The treatment agent target area 32 may, for example, be formed by a building field and/or a powder bed of the 3D printer 22, for example by an area thereof not used for the component, or wherein the treatment agent target area 32 has a target surface 38, for example a transparent and/or wipeable and/or replaceable target surface, such as a sheet of paper or a glass plate.

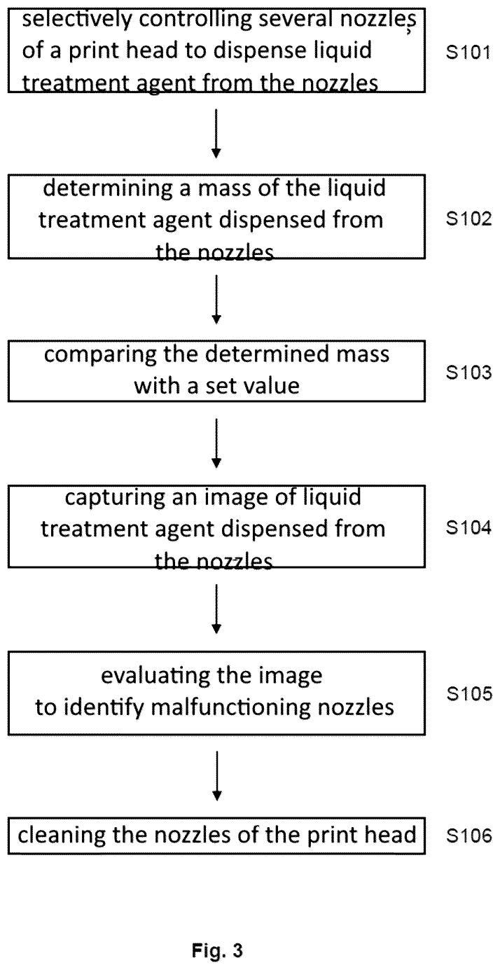

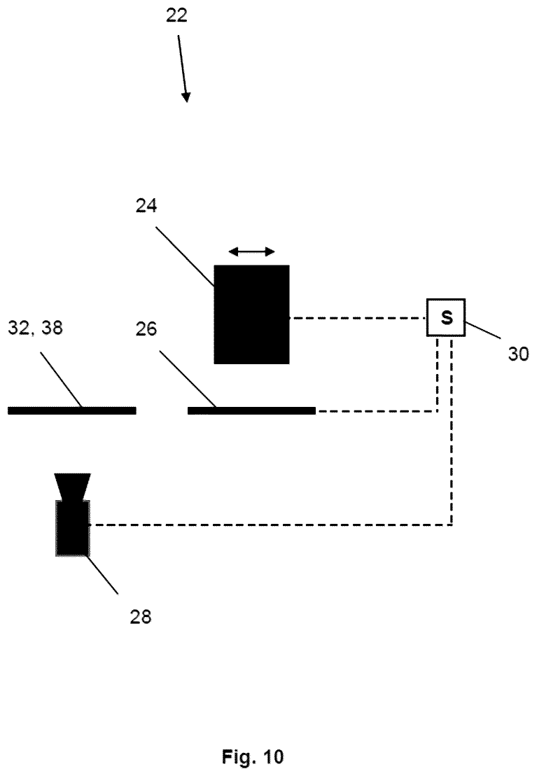

As shown, for example, in FIGS. 7-9 and 11, the image capture device may be arranged, for example, above the treatment agent target area 32 and/or directed toward it. As shown, for example, in FIG. 10, the image capture device 28 may be arranged, for example, below the transparent, for example, wipeable and/or replaceable, target surface 38, for example, the glass plate, and/or directed toward it. As shown in FIG. 3, for example, a method for monitoring the function of a print head 24 of a 3D printer 22 in combination with a method for cleaning the print head 24 may include, for example, cleaning the nozzles of the print head S106, for example by means of a print head cleaning device 36 of the 3D printer 22 and/or by moving the print head 24 across a/the print head cleaning device 36 of the 3D printer 22, for example several times, and/or by flushing the nozzles with liquid treatment agent, wherein the cleaning of the nozzles S106 may be carried out, for example, if malfunctioning nozzles are identified during the evaluation of the image S105 and/or if a deviation from the set value is detected when comparing the determined mass with the set value S103.

After cleaning the nozzles S106, for example, another determination of the mass of the liquid treatment agent S102 dispensed from the nozzles and a comparison of the determined mass with the set value S103 and/or capture and evaluation of an image S104, S105 may be carried out. Cleaning the nozzles S106 and determining the mass of the liquid treatment agent dispensed from the nozzles S102 and comparing the determined mass with the set value S103 and/or capturing and evaluating the image S104, S105 may, for example, be performed repeatedly, for example until the determined mass corresponds to the set value and/or no more malfunctioning nozzles are identified during the evaluation of the image S105 and/or a termination criterion is fulfilled, for example a maximum number of repetitions.

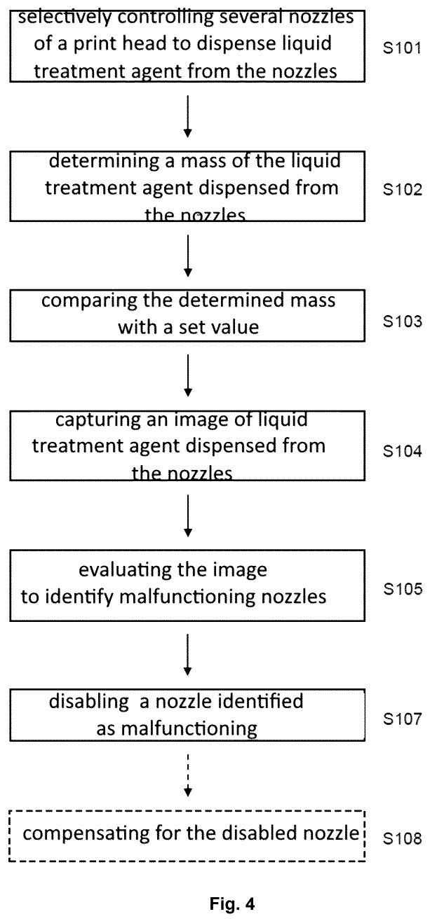

As shown in FIG. 4, for example, a method for monitoring the function of a print head 24 of a 3D printer 22 may comprise, for example: disabling S107 a nozzle identified as malfunctioning and optionally compensating for the disabled nozzle S108, for example by selectively increasing the amount of liquid treatment agent dispensed from one or more nozzles arranged adjacent to the disabled nozzle, and/or by positioning, for example moving, the print head 24 during a second pass of the print head 24 across the building field of the 3D printer 22, so that an area to be printed by the disabled nozzle during a first pass of the print head 24 across the building field is printed by a non-malfunctioning nozzle during the second pass of the print head 24 across the building field.

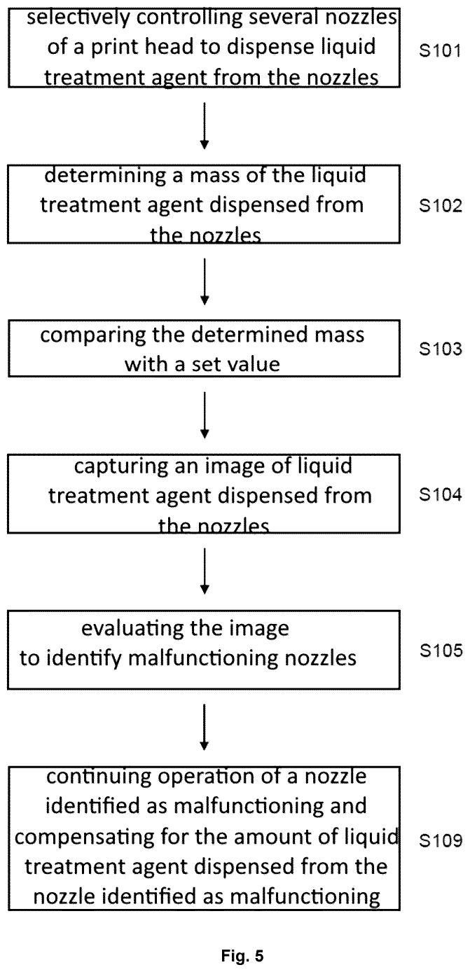

As shown in FIG. 5, for example, a method for monitoring the function of a print head 24 of a 3D printer 22 may comprise, for example: continuing operation of a nozzle identified as malfunctioning and compensating for the amount of liquid treatment agent dispensed from the nozzle identified as malfunctioning S109, for example by selectively adjusting, for example increasing or decreasing, the amount of liquid treatment agent dispensed from one or more nozzles arranged adjacent to the nozzle identified as malfunctioning, and/or by selectively adjusting, for example increasing or decreasing, the amount of liquid treatment agent dispensed from a nozzle identified as having a restricted function to a target amount, for example by adjusting parameters, for example a pulse time and/or a frequency and/or a voltage, for selectively controlling the nozzle identified as malfunctioning.

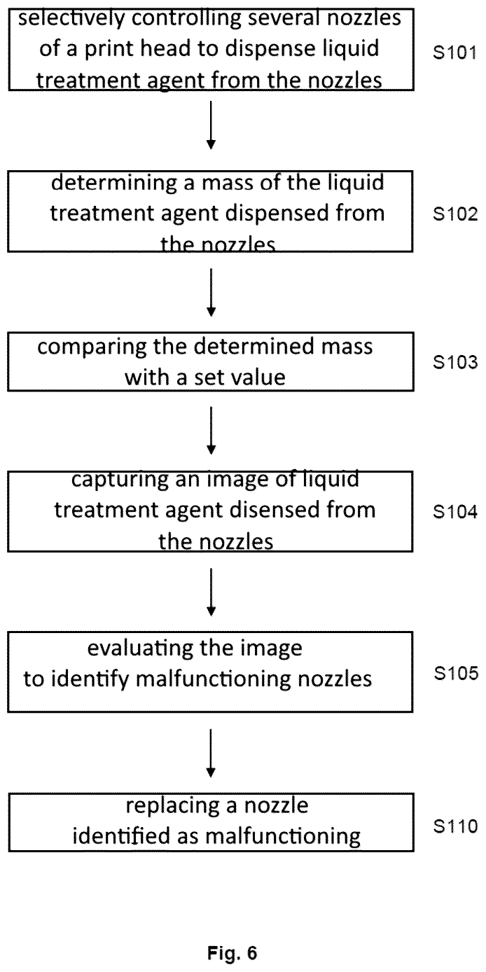

As shown in FIG. 6, for example, a method for monitoring the function of a print head 24 of a 3D printer 22 may include replacing a nozzle identified as malfunctioning S110.

As shown, for example, in FIGS. 7-11, a 3D printer 22, which is configured to build up a component in layers by selectively dispensing liquid treatment agent from nozzles of a print head 24 onto a previously applied layer of loose particle material, may, for example, comprise a print head 24 comprising a plurality of nozzles and configured to selectively dispense a liquid treatment agent from the nozzles, a weighing device 26 which is configured to determine a mass of the liquid treatment agent dispensed from the nozzles, an image capture device 28 which is configured to capture an image of the liquid treatment agent dispensed from the nozzles, and a control device 30 which is configured to compare the mass determined by the weighing device 26 with a set value and to evaluate the image captured by the image capture device 28, in order to identify malfunctioning nozzles, wherein the print head 24 may be positioned above the weighing device 26.

The control device 30 may, for example, be configured to selectively control the nozzles of the print head 24 so that the controlled nozzles receive a signal to dispense the liquid treatment agent. The control device 30 may, for example, be configured to position the print head 24 above the weighing device 26.

As shown, for example, in FIGS. 7-11, the 3D printer may, for example, have a treatment agent target area 32 which is arranged within the 3D printer 22 and is configured to receive the liquid treatment agent dispensed from the nozzles at least for the purpose of capturing the image, wherein the print head 24 may be positioned above the treatment agent target area 32, and wherein, optionally, the control device 30 is configured to position the print head 24 above the treatment agent target area 32.

As shown, for example, in FIGS. 7 and 8, the treatment agent target area 32 may be formed by the weighing device 26, for example by a weighing tray 34 of the weighing device 26, which is, for example, replaceable and/or wipeable.

As shown, for example, in FIGS. 9-11, the weighing device 26 and the treatment agent target area 32 may be arranged separately from one another. The treatment agent target area 32 may, for example, be formed by a building field and/or a powder bed of the 3D printer 22, for example by an area thereof not used for the component. The treatment agent target area 32 may, for example, have a target surface 38, for example a transparent and/or wipeable and/or replaceable target surface, for example a sheet of paper or a glass plate.

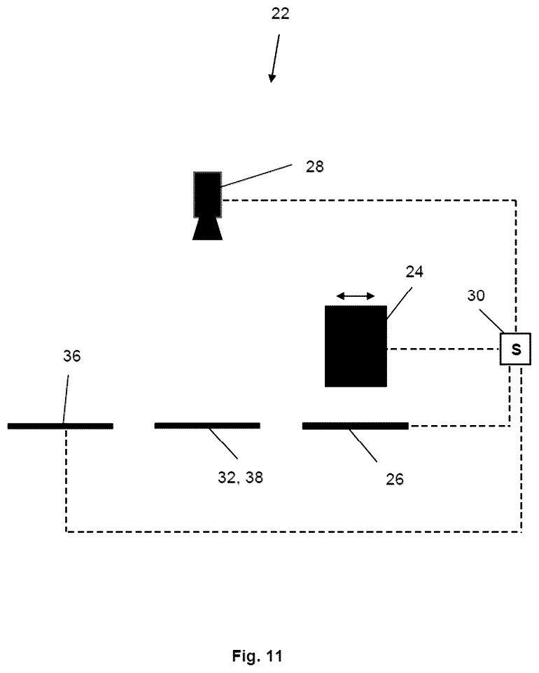

As shown, for example, in FIGS. 7-9 and 11, the image capture device 28 may be arranged, for example, above the treatment agent target area 32 and/or directed toward it. As shown, for example, in FIG. 10, the image capture device 28 may be arranged, for example, below the transparent, for example, wipeable and/or replaceable target surface 38, for example, the glass plate, and/or directed toward it. As shown in FIG. 11, for example, the 3D printer may, for example, comprise a print head cleaning device 36 that is configured to clean the nozzles of the print head 24, wherein the control device 30 may, for example, be configured to move the print head 24 across the print head cleaning device 36, for example multiple times, for cleaning the nozzles. The control device 30 may, for example, be configured to control the nozzles of the print head 24 so that they are flushed with a liquid treatment agent for cleaning the nozzles. The control device 30 may, for example, be configured to control the print head 24 and/or the print head cleaning device 36 in such a way that the nozzles are cleaned if malfunctioning nozzles are identified during the evaluation of the image and/or if a deviation from the set value is detected when the determined mass is compared with the set value. The control device 30 may, for example, be configured to control the print head 24, the weighing device 26 and the image capture device 28 in such a way that, after cleaning the nozzles, the mass of the liquid treatment agent dispensed from the nozzles is determined again and the determined mass is compared with the set value and/or an image is captured and evaluated. The control device 30 may be configured, for example, to control the print head 24 and/or the print head cleaning device 36, the weighing device 26 and the image capture device 28 in such a way that the cleaning of the nozzles and the determination of the mass of the liquid treatment agent dispensed from the nozzles and comparison of the determined mass with the set value and/or the recording and evaluation of the image are performed repeatedly, for example until the determined mass corresponds to the set value and/or no more malfunctioning nozzles are identified during the evaluation of the image and/or a termination criterion is fulfilled, for example a maximum number of repetitions.

The control device 30 may, for example, be configured to automatically evaluate the captured image and/or automatically compare the determined mass with the set value, for example by means of artificial intelligence. The control device 30 may, for example, be configured to control the 3D printer 22 in such a way that one or more of the processes described above are carried out.

The control device 30 may, for example, be configured to compare, when evaluating the image, a dispensing pattern 12a, 12b, 12c formed by the liquid treatment agent dispensed by the print head 24 and captured by the image capture device 28, with an arrangement pattern 10 corresponding to the controlled nozzles of the print head 24, which is stored, for example, in a memory of the 3D printer 22 or is generated depending on the controlled nozzles (see, for example, FIG. 2). The control device 30 may, for example, be configured to compare the entire dispensing pattern 12a, 12b, 12c with the entire arrangement pattern 10, and/or to compare a respective section 16a, 16b, 16c of the dispensing pattern 12a, 12b, 12c with a respective, associated section 14 of the arrangement pattern 10, for example for several or all of the controlled nozzles, and/or to compare an area of a respective spot 20 formed by the dispensed liquid treatment agent in the captured image with a respective associated partial section 18 of the arrangement pattern 10, for example for several or all of the controlled nozzles.

The control device 30 may, for example, be configured to control the print head 24, the weighing device 26, and the image capture device 28 in such a way that a determination of a mass of the liquid treatment agent dispensed from the nozzles and a comparison of the determined mass with the set value is carried out before an image is captured and the image is evaluated. The control device 30 may, for example, be configured to control the print head 24, the weighing device 26, and the image capture device 28 in such a way that the image is captured and evaluated if a deviation from the set value is detected when the determined mass is compared with the set value, and/or the image is captured and evaluated when another predetermined criterion is met, for example, a predetermined number of monitoring operations has been performed or a predetermined time period has elapsed since the last capture and evaluation of an image by the image capture device 28, and/or the capture and evaluation of the image is always or at least partially omitted when the determined mass corresponds to the set value.

The control device 30 may, for example, be configured to control the print head 24 in such a way that a nozzle identified as malfunctioning is disabled and, optionally, the disabled nozzle is compensated for, for example by selectively increasing the amount of liquid treatment agent dispensed from one or more nozzles arranged adjacent to the disabled nozzle and/or by positioning, for example moving, the print head 24 during a second pass of the print head 24 across a/the building field of the 3D printer 22, so that an area to be printed during a first pass of the print head 24 across the building field through the disabled nozzle is printed during the second pass of the print head 24 across the building field through a nozzle that is not malfunctioning, and/or a nozzle identified as malfunctioning continues to operate and the amount of liquid treatment agent dispensed from the nozzle identified as malfunctioning is compensated for, for example by selectively adjusting, for example increasing or decreasing, the amount of liquid treatment agent dispensed from one or more nozzles, arranged adjacent to the nozzle identified as malfunctioning, and/or by selectively adjusting, for example increasing or decreasing, the amount of liquid treatment agent dispensed from a nozzle identified as malfunctioning to a target amount, for example by adjusting parameters, for example a pulse time and/or a frequency and/or a voltage, for selectively controlling the nozzle identified as malfunctioning.

1. A method for monitoring the function of a print head of a 3D printer which is configured to build up a component in layers by selectively dispensing liquid treatment agent from nozzles of the print head onto a previously applied layer of loose particle material, the method comprising:
selectively controlling several nozzles of the print head to dispense liquid treatment agent from the nozzles
determining a mass of the liquid treatment agent dispensed from the nozzles and comparing the determined mass with a set value and
capturing an image of liquid treatment agent dispensed from the nozzles and evaluating the image to identify malfunctioning nozzles.

2. The method according to claim 1,
wherein the determining of the mass of the liquid treatment agent dispensed from the nozzles and the comparing of the determined mass with the set value is performed before the capturing and evaluating of the image.

3. The method according to claim 1, wherein the evaluation of the image comprises:
comparing a dispensing pattern formed by the dispensed liquid treatment agent and recorded, with an arrangement pattern corresponding to the controlled nozzles of the print head.

4. The method according to claim 3, wherein the comparing of the dispensing pattern formed by the dispensed liquid treatment agent and recorded, with the arrangement pattern corresponding to the controlled nozzles of the print head comprises:
comparing the entire dispensing pattern with the entire arrangement pattern, and/or
comparing a respective section of the dispensing pattern with a respective, associated section of the arrangement pattern, for example for several or all of the driven nozzles, and/or
comparing an area of a respective spot formed by the dispensed liquid treatment agent in the captured image with a respective associated partial section of the arrangement pattern.

5. The method according to claim 1,
wherein the capturing of the image is performed by means of an image capture device of the 3D printed, which is configured to capture an image of the liquid treatment agent dispensed from the nozzles, and/or
wherein the print head is positioned for image capture above a treatment agent target area within the 3D printer which is configured to receive the liquid treatment agent dispensed from the nozzles, and/or
wherein the print head for determining the mass of the liquid treatment agent dispensed from the nozzles is positioned above a weighing device of the 3D printer, which is configured to determine the mass of the liquid treatment agent dispensed from the nozzles, and/or
wherein the evaluation of the image and/or the comparison of the determined mass with the set value is performed automatically by means of a control device of the 3D printer.

6. The method according to claim 5,
wherein the treatment agent target area is formed by the weighing device.

7. The method according to claim 5,
wherein the weighing device and the treatment agent target area are arranged separately from each other, and/or
wherein the treatment agent target area is formed by a building field and/or a powder bed of the 3D printer.

8. The method according to claim 5,
wherein the image capture device is arranged above the treatment agent target area and/or directed toward it.

9. The method according to claim 2, further comprising:
cleaning the nozzles of the print head by means of a print head cleaning device of the 3D printer and/or by moving the print head over a/the print head cleaning device of the 3D printer, and/or by flushing the nozzles with a liquid treatment agent,
wherein the cleaning of the nozzles is carried out if malfunctioning nozzles are identified during the evaluation of the image and/or if a deviation from the set value is detected during the comparison of the determined mass with the set value.

10. The method according to claim 9, further comprising:
after cleaning the nozzles, performing another determination of the mass of the liquid treatment agent dispensed from the nozzles and comparison of the determined mass with the set value and/or a capturing and evaluating of an image.

11. The method according to claim 1, further comprising:
disabling a nozzle identified as malfunctioning.

12. The method according to claim 1, further comprising:
continuing operation of a nozzle identified as malfunctioning and compensating for the amount of liquid treatment agent dispensed from the nozzle identified as malfunctioning.

13. The method according to claim 1, further comprising:
replacing a nozzle identified as malfunctioning

14. A 3D printer which is configured to build up a component in layers by selectively dispensing liquid treatment agent from nozzles of a print head onto a previously applied layer of loose particle material, the 3D printer comprising:
a print head comprising a plurality of nozzles and configured to selectively dispense a liquid treatment agent from the nozzles,
a weighing device which is configured to determine a mass of the liquid treatment agent dispensed from the nozzles,
an image capture device configured to capture an image of the liquid treatment agent dispensed from the nozzles, and
a control device which is configured to compare the mass determined by the weighing device with a set value and to evaluate the image captured by the image capture device in order to identify malfunctioning nozzles,
wherein the print head is positionable above the weighing device.

15. The 3D printer according to claim 14,
wherein the control device is configured to selectively control the nozzles of the print head so that the controlled nozzles receive a signal to dispense the liquid treatment agent, and/or
wherein the control device is configured to position the print head above the weighing device.

16. The 3D printer according to claim 14, further comprising:
a treatment agent target area arranged within the 3D printer and configured to receive the liquid treatment agent dispensed from the nozzles at least for capturing the image,
wherein the print head is positionable above the treatment agent target area.

17. The 3D printer according to claim 16,
wherein the treatment agent target area is formed by the weighing device.

18. The 3D printer according to claim 16,
wherein the weighing device and the treatment agent target area are arranged separately from each other, and/or
wherein the treatment agent target area is formed by a building field and/or a powder bed of the 3D printer, for example by an area thereof not used for the component, or wherein the treatment agent target area has a target surface.

19. The 3D printer according to claim 16,
wherein the image capture device is arranged above the treatment agent target area and/or directed toward it.

20. The 3D printer according to claim 14, further comprising:
a print head cleaning device which is configured to clean the nozzles of the print head,
wherein the control device configured to move the print head across the print head cleaning device (36), and/or
wherein the control device is configured to control the nozzles of the print head so that they are flushed through with a liquid treatment agent for cleaning the nozzles.

21. The 3D printer according to claim 14, wherein the control device is configured to
automatically evaluate the captured image and/or automatically compare the determined mass with the set value,

22. The 3D printer according to claim 14, wherein the control device is configured to, when evaluating the image:
compare a dispensing pattern formed by the liquid treatment agent dispensed by the print head and captured by the image capture device with an arrangement pattern corresponding to the controlled nozzles of the print head.

23. The 3D printer according to claim 14, wherein the control device is configured to control the print head the weighing device and the image capture device in such a way that:
a determination of a mass of the liquid treatment agent dispensed from the nozzles and a comparison of the determined mass with the set value is carried out before a capturing of an image and an evaluation of the image.

24. The 3D printer according to claim 14, wherein the control device is configured to control the print head in such a way that
a nozzle identified as malfunctioning is disabled, and/or
a nozzle identified as malfunctioning continues to operate and the amount of liquid treatment agent dispensed from the nozzle identified as malfunctioning is compensated for.
